(19) United States
(12) Patent Application Publication
(10) Pub. No.: US 2010/0254154 A1
(43) Pub. Date: Oct. 7, 2010

(54) Central laser source based passive countermeasure system

(75) Inventors: Neal E. Fine, North Kingstown, RI (US); David C. Kring, South Kingstown, RI (US); Curtis A. Birnbach, New Rochelle, NY (US)

Correspondence Address: TOBIN, CARBERRY, O'MALLEY, RILEY, SELINGER, P.C., 43 BROAD STREET, PO BOX 58, NEW LONDON, CT, 06320, US

(73) Assignee: Flight Safety Technologies, Inc, Mystic, CT (US)

(21) Appl. No.: 11/786,679

(22) Filed: Apr. 11, 2007

Related U.S. Application Data
(60) Provisional application No. 60/791,752, filed on Apr. 12, 2006.

(51) Int. Cl. H01S 3/00

(52) U.S. Cl. 362/553

(57) ABSTRACT

The disclosure is directed toward a central laser source based passive countermeasure system for use on an emission producing asset comprising at least one centrally located source disposed on the emission producing asset. The centrally located source is configured to produce optical energy in at least one band of infrared radiation. At least one first fiber optic wire is coupled to the centrally located source to transmit the optical energy. At least one modulator is coupled to the centrally located source via the first fiber optic wire and is configured to modulate a flow of the optical energy. At least one output lens assembly is coupled to the modulator via a second fiber optic wire and is configured to receive the optical energy and emit the optical energy.

### PRIORITY CLAIM

This Application claims priority to Provisional Patent Application No. 60/791,752 entitled “Central Laser Source Based Passive Countermeasure System”, filed on Apr. 12, 2006, the disclosure of which is incorporated herein by reference in its entirety.

### BACKGROUND

Infrared (IR) radiation countermeasure systems for aircraft have been developed to thwart seeker missiles and other types of threat vehicles. Some IR countermeasure systems work by first detecting a missile launch, then initiating a spurious radiation signature substantially more intense than that produced by the aircraft's engines, from a location displaced from the aircraft. The source of the spurious radiation is typically ejected (or otherwise physically removed or displaced) from the immediate vicinity of the host aircraft (e.g., firing flares or towing a decoy). Thus, the IR guided missile is attracted towards the source of the spurious radiation signature, away from the target aircraft.

One type of countermeasure system is disclosed in U.S. Pat. No. 6,825,791 (hereafter “the '791 Patent”) to Sanders et al. The '791 Patent discloses a deceptive signature broadcast system for an aircraft (or other emissions generating asset). The system generates an emissions pattern that masks the normal emissions signature of the aircraft or asset. The system protects it from emissions tracking intercept vehicles, such as IR tracking missiles. The system includes at least two beacons mounted in a spaced apart arrangement orthogonal to the desired zone of protection, and bracketing the asset, such as on opposite wingtips of the aircraft for fore and aft protection. The beacon set is modulated from one end to the other with a sweeping pattern of emission intensity, deceptively indicating to the intercepting vehicle a lateral component of motion of the aircraft away from its true relative position within the intercept vehicle's field of view, thereby inducing the intercept vehicle to adopt an erroneous and exaggerated lead angle and course correction that results in a missed intercept trajectory. Unfortunately, the '791 Patent requires many expensive additional components for providing the synchronized, multi-source radiation broadcast system.

As is well understood in the art, jet engine IR signatures of the engine metal at the inlet, or outlet, fall generally in the region of Band 1, which is the reason that threat missile guidance systems operate in this region. However, some guidance systems utilize a Band 4 or a dual-band sensor system to provide for greater reliability of the tracking system. Unfortunately, efficiently generating Band 1 and Band 4 energy remains a difficult challenge.

Existing countermeasure systems require the deceptive (or jammer) emissions from a countermeasure system to have greater power than the host asset's inherent emission signature. These deceptive emissions require a large amount of power in order to draw the missile away from the host asset. This requirement often renders the prior art countermeasure systems impractical and expensive.

What is needed in the art is a specialized infrared source that emits IR in the appropriate ranges, and has low power requirements and is light weight.

### SUMMARY

The following presents a simplified summary of the present invention in order to provide a basic understanding of some aspects of the present invention. This summary is not an extensive overview of the present invention. It is not intended to identify key or critical elements of the present invention or to delineate the scope of the present invention. Its sole purpose is to present some concepts of the present invention in a simplified form as a prelude to the more detailed description that is presented herein.

The disclosure is directed to a central laser source based passive countermeasure system for use on an emission producing asset comprising at least one centrally located source disposed on the emission producing asset. The at least one centrally located source is configured to produce optical energy in at least one band of infrared radiation. At least one first fiber optic wire is coupled to the at least one centrally located source to transmit the optical energy. At least one modulator is coupled to the at least one centrally located source via the at least one first fiber optic wire and is configured to modulate a flow of the optical energy. At least one output lens assembly is coupled to the at least one modulator via at least one second fiber optic wire and is configured to receive the optical energy and emit the optical energy.

A method of using a central laser source based passive countermeasure system on an emission producing asset is disclosed. The method comprises activating at least one centrally located source to produce optical energy in at least one band of infrared radiation. Coupling the at least one centrally located source to at least one first fiber optic wire. Transmitting the optical energy through the at least one first fiber optic wire to at least one modulator. Modulating a flow of the optical energy in the at least one modulator. Transmitting the flow of the optical energy to at least one output lens assembly via at least one second fiber optic wire. Emitting the flow of the optical energy from the at least one output lens assembly.

This disclosure is directed toward a method of using a central laser source based passive countermeasure system on an emission producing asset. The method comprises generating Band 1 and Band 4 infrared energy with a centrally located laser, modulating that light and distributing it to output couplers at various locations on the emission producing asset.

### BRIEF DESCRIPTION OF THE FIGURES

Referring now to the figures, wherein like elements are numbered alike:

FIG. 1 is a top view of an aircraft incorporating the tactical integrated illumination countermeasure system;

FIG. 2 is a graph of the intensities of IR radiation being emitted from the left wingtip lighting assembly over time;

FIG. 3 is a graph of the intensities of IR radiation being emitted from the tail tip lighting assembly over time;

FIG. 4 is a graph of the intensities of IR radiation being emitted from the right wingtip lighting assembly over time;

FIG. 5 is a graph of the apparent position of the deceptive signature pattern generated by the waveforms of a three beacon set;

FIG. 6 illustrates a top view of an aircraft incorporating additional lighting assemblies into the tactical integrated illumination countermeasure system;

FIG. 7 illustrates additional lighting assemblies that are electrically coupled to the existing lighting assembly system to accommodate large aircraft;

FIG. 8 is a graph illustrating the apparent position of the deceptive signature pattern generated by the waveforms of the five lighting assembly system of FIG. 7;

FIG. 9 is a top view of an aircraft incorporating the tactical integrated illumination countermeasure system;

FIG. 10 is an illustration of an exemplary countermeasure system having a central light source that delivers optical energy to an output lens assembly;

FIG. 11 is an illustration of an exemplary countermeasure system having two central light sources that deliver optical energy to an output lens assembly; and

FIG. 12 is an illustration of an exemplary countermeasure system having two central light sources that deliver optical energy to several output lens assemblies.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

In a preferred embodiment, the present invention comprises utilizing a specialized lighting source a central location of an aircraft. This source emits infrared light in both Band 1 and Band 4 regions of the spectrum required by missile countermeasures.

For the countermeasure embodiment, the specialized source can be utilized to provide synchronized patterns of IR radiation emission, at appropriate cycle times, of high and low level intensities of radiation at the period of interest in the normally emitted radiation signature; high level intensity being greater than the normal radiation signature intensity of the aircraft. The period of the pattern (or flashing) of infrared light from side to side (e.g., left to right or right to left or randomly within appropriate times or “sweep” time) can be about 3.0 seconds to about 0.1 second.

Using this sweep-modulated broadcast technique, an exaggerated zigzag pattern of intercept is induced, whereby an incoming missile is attracted to the first (or lead-off) beacon, then swept to the other (or trailing) beacon by the shifting center of intensity so as to erroneously interpret a lateral motion (or displacement) of the aircraft that in turn induces an erroneous and excessive lead angle at each zig; then zagging back to the lead off beacon when the broadcast cycle starts anew. When the missile closes in on the aircraft such that the lead off beacon falls out of the missile's field of view, the missile continues on its last erroneous lead angle, by which time it is likely too late to make a useful correction and the intercept fails.

More particularly, the present invention also includes a snapback (or reset) time at the end of the modulation cycle for resetting all beacons in the set to their respective initial high and low power settings. A snapback time is sufficiently short so that it has no significance to the missile response time or to the proportional navigation guidance system response time. The snapback time can be about 10% of the sweep time, a preferable time is about 1 millisecond to about 200 milliseconds, with about 10 milliseconds to about 150 milliseconds preferred. When this pattern of sweep modulation and snap back is repeated in synchronous fashion by the set of beacons, the deceptive signature indicating an apparent movement in the selected direction causes the missile to make an oscillating, or zigzag-like, approach. The missile makes a long “zig” for the duration of the sweep cycle to follow the deceptive signature sweep, and builds in a correcting lead angle that would lead to a missed-intercept trajectory by the guidance system. At the point that the sweep cycle ends and the snapback occurs, if the first beacon remains within the field of view of the seeker, the seeker may “see” the first beacon restart and begins a reversing “zag”; a correction back towards the first beacon within the limits of its response time. The attempted course reversal or “zag” is of short duration, however, as the sweep modulation immediately induces another reversing “zig” in the direction of the signature sweep, with its longer duration, again inducing an erroneous correcting lead angle in the direction of the signature sweep. Eventually, when the missile is close enough, the originating or ramp down beacon, or beacons, fall out of the field of view. Thereupon, the missile continues on its last erroneous lead angle, taking it outboard of the last or most outboard beacon and wingtip, resulting in a missed intercept.

Vulnerability to man-portable and shoulder-fired radiation seeking missiles is highest during take-off and landing operations, from the ground surface up to an altitude of about 20,000 feet. Missile launchers prefer to have a head-on or tail view of the aircraft engines where the IR radiation signatures are strongest, and where acquisition and firing tones will be emitted as a lock-on signal before firing. The immediate vicinity of runways and airports is generally protected against unauthorized access, but the zone of vulnerability to a surface based missile launch from ahead of or behind the aircraft extends some distance out beneath the take off and landing zones. For the best fore and aft zones of protection, a wingtip to wingtip design encompassing a tail and nose beacon is the basic configuration of choice. Of course other configurations are within the scope of the invention, depending on factors such as the aircraft size and configuration, the normally emitted radiation signature pattern and intensity of the aircraft, the desired zones of protection, and the type and performance characteristics of the threat vehicle. A preferred embodiment includes utilizing beacons at both wingtips, the nose, the tail, and a central location at the belly of the aircraft. In this preferred embodiment, the aircraft would have countermeasure coverage over all missile approach zones.

As will be further appreciated by those skilled in the field, significant high intensity radiation at other than IR radiation wavelengths may be detectable on or emitted from various possible sources on an aircraft. Recognizing that multi-band sensors are not uncommon and may be expanded or revised to target other peak intensity wavelengths of the aircraft's total radiation signature, the present invention contemplates the use of single, dual and multi-band beacon systems that emit deceptive patterns of radiation in any mix of wavelengths from visible to ultraviolet through long wave infrared inclusively, at which guidance systems may be known or developed to detect and track. The bands or wavelengths may be switchable or selectable in some beacons and some system configurations, to address different threats at different times and places.

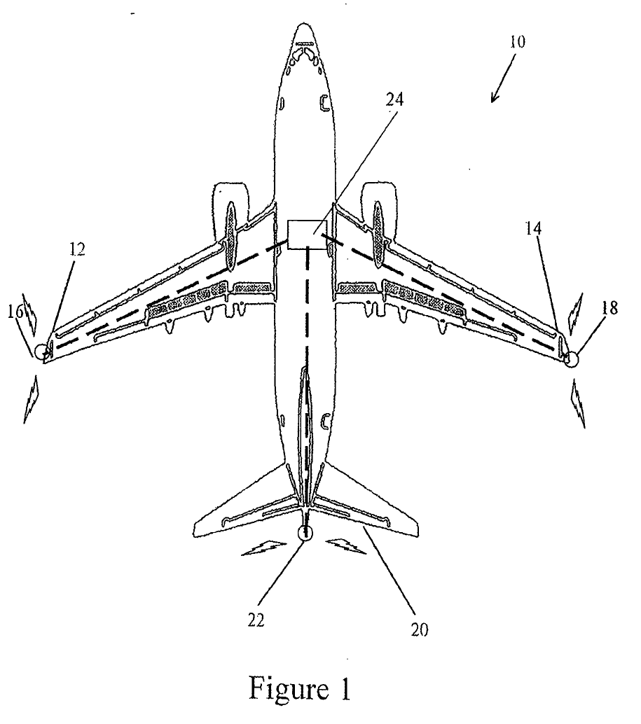

Referring now to FIG. 1, a top view of an aircraft 10 is shown. On each wingtip 12, 14 of the aircraft 10 is the standard beacon (or lighting assembly or emitter) 16, 18. On the tail tip 20, another standard beacon 22 is disposed. Depending upon the size of the aircraft (or asset or body), other beacons (not shown) may be installed to provide adequate countermeasure sequencing.

In preferred embodiments for the countermeasure use, the low or threshold level intensity of a beacon is about 0.1 times normal emissions of the aircraft so as to remain visible to the threat vehicle as compared to the normal aircraft emissions intensity, and full intensity is not less than about 10 times normal aircraft emissions intensity. In a preferred embodiment, the radiant intensity of the beacon is about 0.05 times to about 2.0 times the normal emissions of the aircraft, with a preferred radiant intensity of about 0.1 times to about 0.9 times the normal emissions of the aircraft. Although a lower differential between the normal and the low or threshold beacon intensity, and/or a full beacon intensity of less than twice normal aircraft emissions intensity, may still be effective for confounding some threat vehicles.

A weatherproof envelope (or shield or outer shield) (not shown) made of material substantially transparent to the emissions of interest, may be required to protect the functional components of the beacons from exposure to the elements. Several materials contemplated include sapphire, aluminum oxide, polycrystaline alumina, barium fluoride, calcium fluoride, silica, fused silica, magnesium fluoride, zinc sulfide, silicon, and the like.

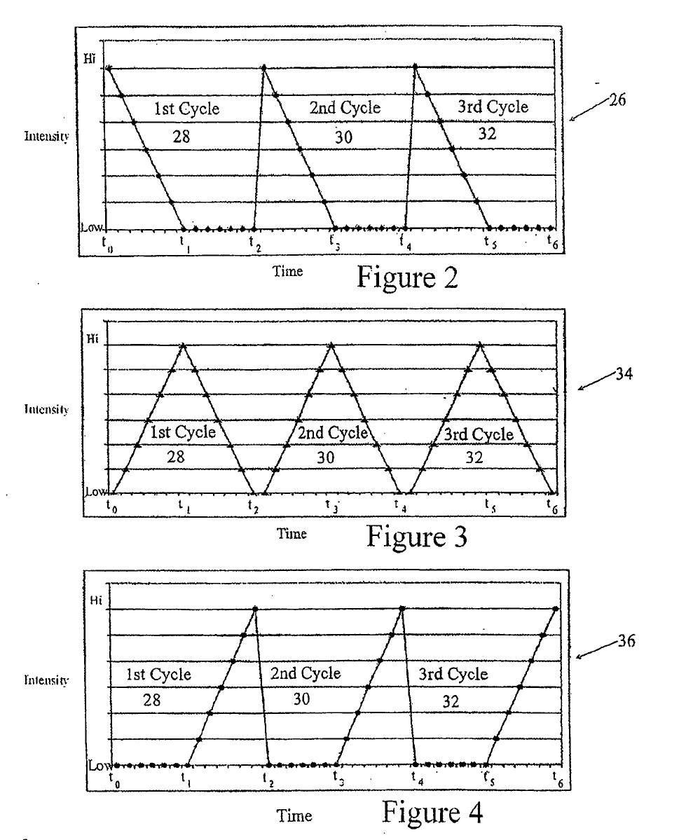

Referring to FIGS. 2, 3, and 4, graphs of the intensities of the IR radiation intensity of the left wingtip beacon 16 (Graph 26), right wingtip beacon 18 (Graph 36), and tail tip beacon 22 (Graph 34) over time is illustrated. The view would be, for example, from aft of the aircraft by a missile with all beacons within its field of view. The IR radiation emissions are operated in a serial sequence of changing intensities that results in a deception of signature pattern. In the first half of cycle 28, from t₀ to t₁, left wingtip beacon 16 begins at high intensity (i.e., Hi) and then ramps down (i.e., decreases in intensity) while tail tip beacon 22 ramps up from low intensity, and right wingtip beacon 18 remains at low intensity. In the second half of cycle 28, from t₁ to t₂, left wingtip beacon 16 remains at low intensity while tail tip beacon 22 ramps down from high intensity to low intensity and right wingtip beacon 18 ramps up from low intensity to high intensity. At time t₂, left wingtip beacon 16 snaps back to full intensity (i.e., Hi), and right wingtip beacon 18 snaps back to low intensity. This completes a full modulation cycle, which is then repeated through times t₃, t₄, t₅ and t₆ to complete the second cycle 30 and third cycle 32, and can be further repeated in successive cycles. It will be readily apparent that the average radiation intensity of the three beacon system remains substantially uniform, from the perspective of an approaching missile.

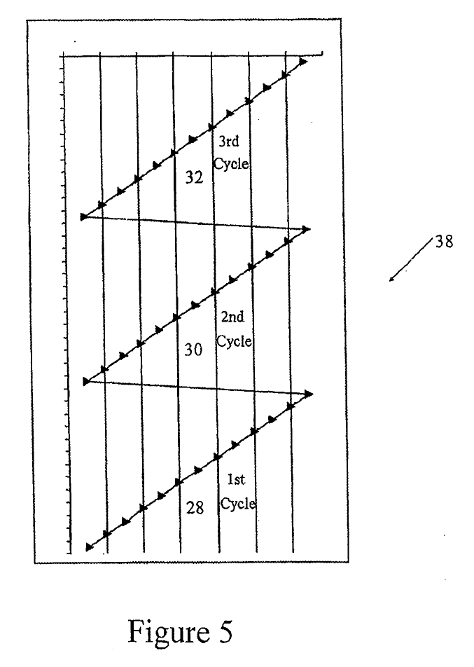

Referring to FIG. 5, the apparent position of the deceptive signature pattern generated by the waveforms of the three beacon set is illustrated in Graph 38. During the first cycle 28, the beacons 16, 18, and 22 create a deceptive signature pattern traveling from left (i.e., starting with left wingtip beacon 16) through center (i.e., tail tip beacon 22) to right (i.e., finishing with right wingtip beacon 18) at a uniform rate over a full cycle (or sweep) of the beacon set. The false pattern is repeated continuously (i.e., as illustrated with second cycle 30 and third cycle 32), creating the zigzag missile trajectory across the full beacon set until the missile sensors are too close to pick up the left wingtip beacon 16. Thereafter, for a short time, the missile guidance system reacts only to tail tip beacon 22 and loses left wingtip beacon 16 from its field of view. The remaining time to target is too short for the next beacon ramp up (i.e., right wingtip beacon 18) to provide a useful correction by the missile, and thus the missile misses the aircraft 10.

For the missile's guidance computer, the effect of each sweep or modulation cycle is a false signature or deceptive indication that the aircraft position is moving from left to right within the missile's field of view, relative to its actual position and flight path. The false signature induces a change of lead angle in the missile's guidance system to the right, ultimately resulting in a missed intercept, typically by about 2 feet to about 200 feet; typically the range is about 10 feet to about 100 feet. Since most surface-to-air IR radiation guided missiles have contact fuses, such a miss distance is acceptable. Other embodiments may employ longer or shorter sweep times and/or snap back times, using mechanical or electronic techniques. In alternative embodiments, the modulation cycle can move from right to left or in a random pattern within appropriate times.

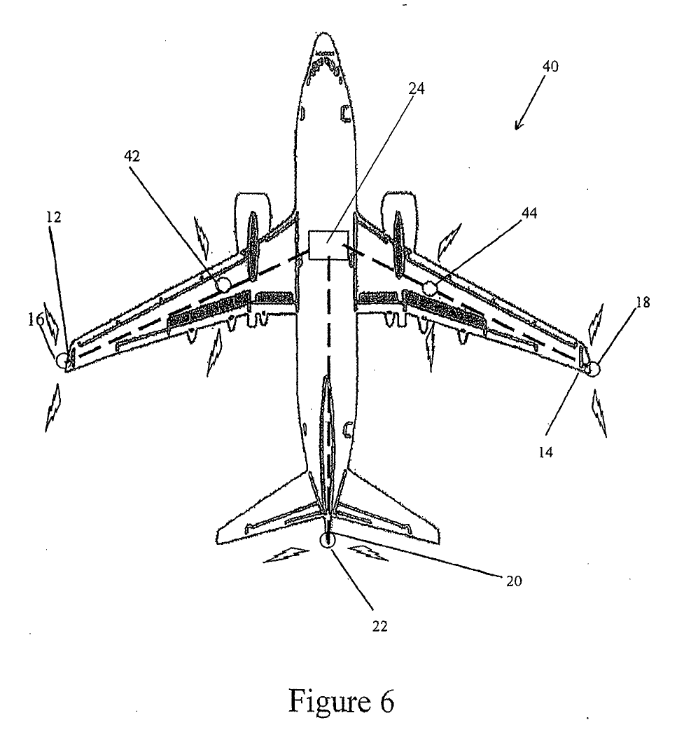

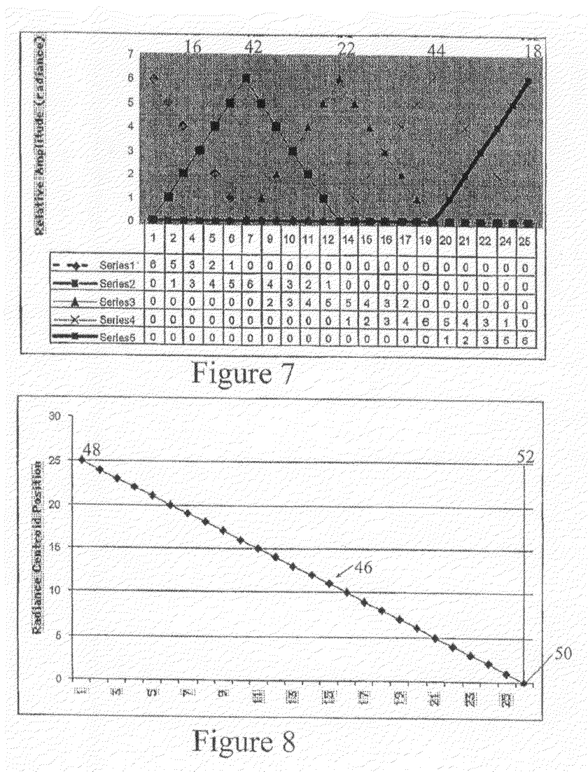

A four or more beacon system may be similarly oriented and operated. While uniform beacon spacing is preferred, some degree of unequal spacing can be tolerated so long as the ramp timing of adjacent beacons is adjusted for the difference, so as to maintain a uniform signature sweep rate across the full set. This concept is illustrated in FIGS. 6 and 7, in which additional beacons may be electrically coupled to the existing beacon system to accommodate large aircraft.

Referring now to FIG. 6, a top view of a large aircraft 40 is shown. On each wingtip 12, 14 of the aircraft 40 is the standard beacon 16, 18. On the tail tip 20, another standard beacon 22 is disposed. Additional beacons 42, 44 can be disposed in electrical communication with the aircraft illumination system to be included in the countermeasure sequencing.

Referring to FIG. 7, the series of beacons 16, 18, 22, 42, and 44 are configured to span a large aircraft (or asset or body) 40. The beacons are relatively closely spaced and operated in sequence, so as to create the desired modulation effect (e.g., as a multi-element sign indicating a lane merge on a highway construction project, or the instrument approach lights on an airport runway that strobe in a repetitive sweep pattern towards the runway threshold). For example, during a first cycle, the beacons 16, 42, 22, 44, and 18 create a deceptive signature pattern traveling from left (i.e., starting with left wingtip beacon 16) to mid-wing (i.e., mid-wingtip beacon 42) through center (i.e., tail tip beacon 22) to mid-wing (i.e., to mid-wingtip beacon 44) to right (i.e., finishing with right wingtip beacon 18) at a uniform rate over a full cycle (or sweep) of the beacon set. The intensity of the beacons is increased to peak intensity and then decreased to create the zigzag pattern. The false pattern is repeated continuously, creating the zigzag missile trajectory across the full beacon set until the missile sensors are too close to pick up the left wingtip beacon 16 and the mid-wing beacon 42. Thereafter, for a short time, the missile guidance system reacts only to tail tip beacon 22 and loses both left wingtip beacon 16 and mid-wing beacon 42 from its field of view. The remaining time to target is too short for the next beacon ramp up (i.e., from mid-wing beacon 44 to right wingtip beacon 18) to provide a useful correction by the missile, and thus the missile misses the aircraft 40. During the course of the cycles, there is a gradual increase and decrease of the intensity of the beacon to create the zigzag effect.

Referring now to FIG. 8, the apparent position of the deceptive signature pattern 46 generated by the waveforms of the five beacon system of FIGS. 7 and 8 is illustrated. The beacons create a deceptive signature pattern traveling from left 48 to right 50 at a uniform rate over a full cycle (or sweep) of the beacon set. The false pattern is repeated continuously (i.e., the pattern repeats at point 52) creating the zigzag missile trajectory across the full beacon set until the missile sensors are too close to pick up the wingtip beacon. The false pattern repeats itself and the missile is unable to provide a useful correction, and thus the missile misses the aircraft.

When the number of beacons in the span is larger, preferably at least five, and spacing of the beacons is sufficiently small relative to the full span of the beacon set, preferably not more than 1/5 span, the requirement for modulation of each individual beacon may be reduced to a simple synchronized switching to high intensity for a specific time and back to low intensity for a specific time, such that the net effect of all beacons with respect to the seeker is substantially the same as in other embodiments. This may simplify the design and operation of the individual beacons.

Longer and shorter sweep times than the about 0.1 to about 3.0 seconds, with about 0.1 to about 1.5 seconds preferred, may be desirable whether controlled by fixed or variable means, depending on beacon spacing and anticipated defensive requirements. For example, for about a 50 foot beacon span, about a 0.5 second sweep time may be effective. For about a 200 foot span, a longer total time, such as about 1.0 second, may be effective.

As long as at least two modulated IR radiation beacons are within the field of view or beam width of the missile, the missile thinks the aircraft is moving the distance and direction between the two beacons in the sweep time provided, and responds with a correction to its intercept path in the direction of the sweep. By then snapping off the last beacon and restarting the beacon set with a new modulation sweep, the target (or host aircraft) appears to the missile to continue to emit the same deception, inducing a further correction in the same direction to the missile's intercept path until the missed intercept trajectory is probable.

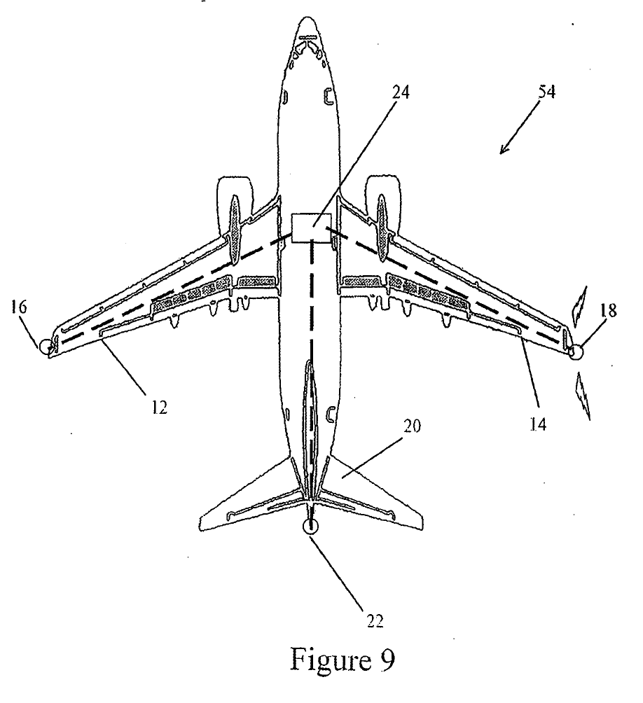

In an alternative embodiment, a one beacon system may be similarly oriented and operated. In this case, only one beacon is operated to create a “walking centroid” effect. The sum of the countermeasure source and the signature from the asset produces an artificial target motion, which misdirects the incoming missile. The centroid is the average position of the signature of the asset and the signature of the countermeasure as seen by the incoming missile. This concept is illustrated in FIG. 9, in which only one beacon is utilized in the existing lighting system of an asset.

FIG. 9 illustrates a top view of an aircraft 54. On each wingtip 12, 14 of the aircraft 54 is the standard beacon 16, 18. On the tail tip 20, another standard beacon 22 is disposed. In this embodiment, only one beacon 18 is illuminated. In this embodiment, the one beacon 18 may contain one or multiple sources which can emit both visible and IR or ultra-violet light. A one beacon system will direct an incoming missile in the direction of the “walking centroid” off the engine. As the missile closes in on the aircraft, the walking centroid effect will direct the missile away from the engines and aircraft.

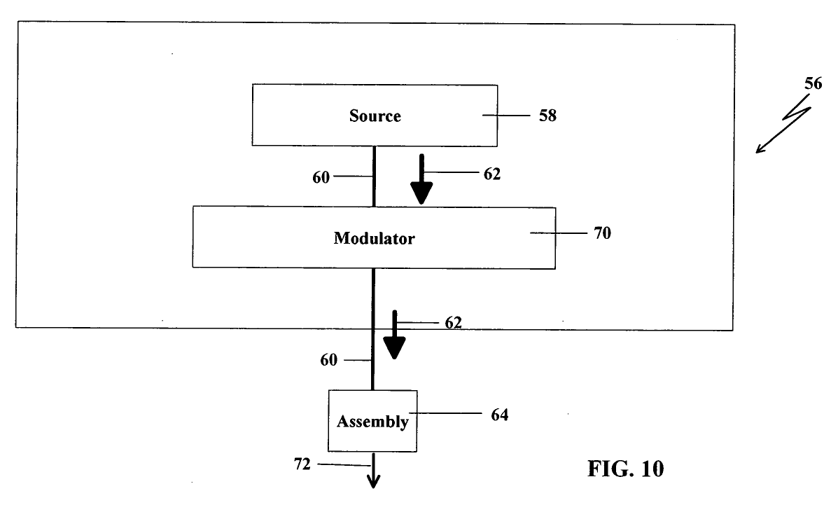

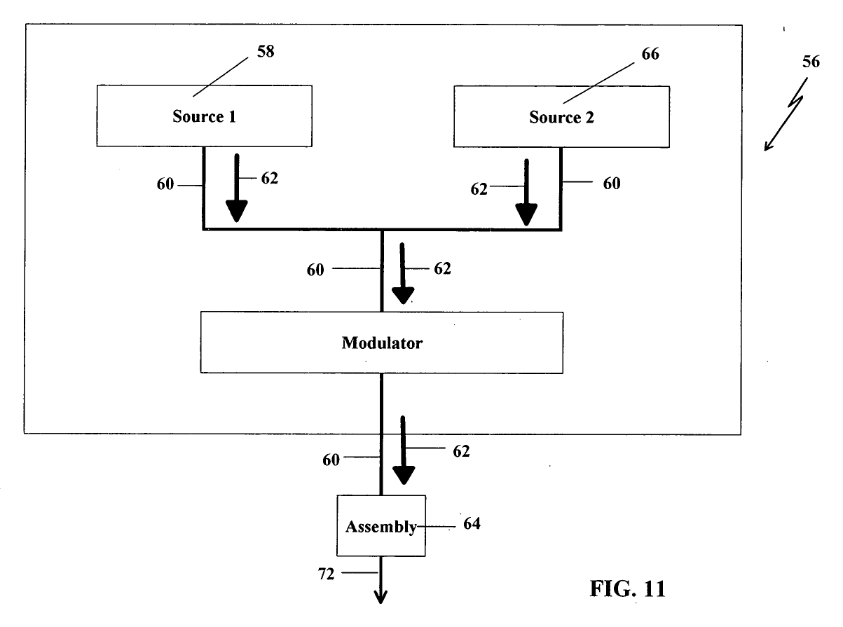

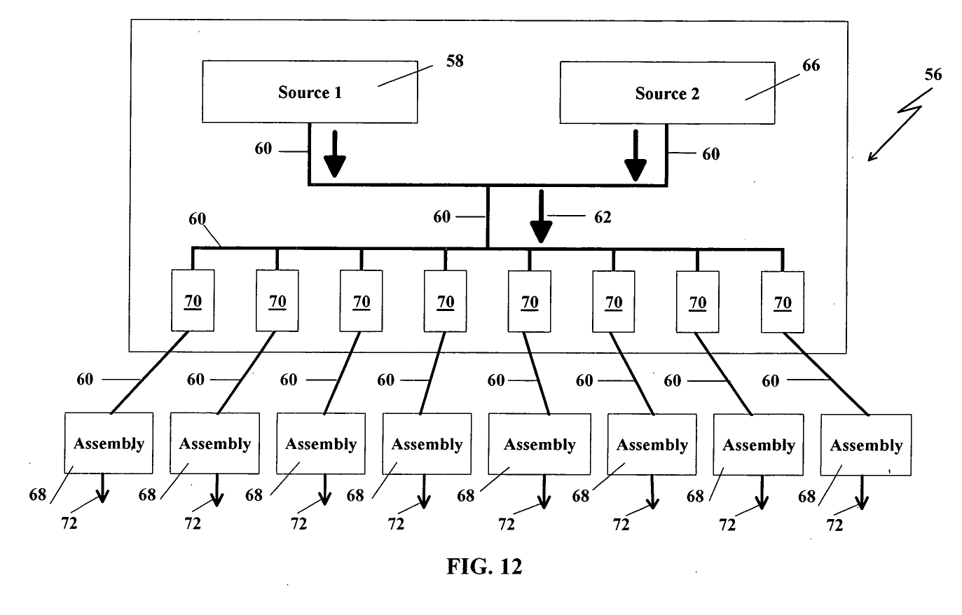

Referring to FIGS. 10, 11, and 12, an exemplary countermeasure system 56 is illustrated. Referring now to FIG. 10, the present invention is a countermeasure system 56 having a flexible architecture that incorporates the use of at least one central light source 58 and fiber optic fibers (or optical fiber wires or fiber optic interconnects) 60 to deliver optical energy (represented by arrow 62) to at least one output lens assembly (or aerodynamic output modules) 64. FIG. 11 illustrates the use of two central light sources 58, 66. FIG. 12 illustrates the use of two central light sources 58, 66 distributing optical energy 62 to several output lens assemblies 68. The central light source 58, 66 utilizes at least one internal electro-optic modulators (or modulator) 70 as illustrated in FIGS. 10 and 11, or several modulators 70 as illustrated in FIG. 12. The modulators 70 are solid state devices that can modulate the flow of the optical energy 62 or can produce an amplitude profile directly, similar to the patterns illustrated in FIGS. 2, 3, 4, 5, and 7.

A centralized lighting source 58, 66 is utilized to produce the optical energy (i.e., infrared light) 62 and then transmit to at least one specialized lens 68 via a series of fiber optic fibers 60. The central light source 58, 66 produces optical energy 62. The central light source 58, 66 can be a carbon monoxide laser or a solid state laser. The central light source 58, 66 can be utilized to provide varying frequencies of IR (i.e., Band 1, Band 4). The laser system can comprise a laser that has an output of about 200 watts to about 1500 watts.

The fiber optic fiber 60 is typically constructed with protective armor and jackets and is of a much lighter weight than copper wire. The typical weight of fiber optic fibers is about 14 pounds per 1000 feet. A fiber optic fiber can maintain power levels of about 1 GW/cm². The core diameter of the fiber optic fiber 60 is between about 200 microns to about 700 microns. The larger cores have lower attenuation factors but require a larger bending radius (e.g., 200 micron fiber requires a 1 cm bend, 400 microns requires 4 cm bend, etc.).

The intensity of the optical energy 62 can be modulated by at least one modulator 70 that is a solid state electro-optical device. The modulator 70 is extremely rugged and have microsecond (or faster) range response times. The modulator can produce a continuously varying output in response to input of an amplitude profile, as indicated above. The modulator 70 consists of an electro-optic layer surrounded by transparent conductor layers and anti-reflection coating layers, which is then surrounded by a pair of crossed polarizers. The modulator 70 operates by providing a variable phase retardation of the input signal in response to the drive signal. The variable phase is translated into variable amplitude by the polarizers. The resolution (i.e., extinction ratio) can be between about 100:1 and about 1,600,000:1, with a preferred ratio of about 4000:1. The preferred electro-optic modulator 70 is a 10 mm clear aperture Pockels Cell.

The output lens assembly 68 is utilized to diffuse and shape the optical energy 62 directed from the centralized laser 58, 66 via a fiber optic fiber 60 to create optical energy 72 for use in thwarting approaching missiles. The output lens assembly (or aerodynamic output modules) 68 can be an aspheric output and fiber interface mounted in a hermetically sealed aerodynamically shaped housing. A fiber optic fiber 60 is coupled to the rear of the output lens assembly 68 via a standard connector. Therefore, installation and replacement of the output lens assembly is easily accomplished. The output lens assembly can also be equipped with the capability to perform de-icing functions, if needed. The aspheric optical element can have anti-reflection coatings to maximize output. Several different physical configurations of this are contemplated dependent on the location on the aircraft or stationary asset.

The present invention is inclusive of multi-band IR radiation beacons. While contemporary threats are generally expected to be in the short and medium IR range, the present invention extends to long wave infrared and ultraviolet wavelengths as well, where new and evolving threats can be expected to materialize.

The preferred embodiment for the present invention is the Band 1 and Band 4 infrared seekers. It is also contemplated for the present invention to be used to counter missiles that home on any signature in the electromagnetic band since the present invention “spoofs” the proportional navigation control and does not rely on jamming a particular type of seeker. Specialized lens or electromagnetic emitters can be utilized to counter missiles that home on radar signatures, visible light, ultraviolet light, or any other part of the electromagnetic spectrum.

Although not necessary, the present invention can be integrated with an onboard missile detection system or connected to airborne communications equipment receiving signals from remote missile detection systems, whether aerial, ground, or sea based, for receiving real time information for automated or manual actuation, modification, or reconfiguration of the deceptive signature broadcast system operating parameters.

The present invention may emit a deceptive signature omni-directionally, directionally, or bi-directionally, and have directionally independent phasing or common field of view phasing between lighting assemblies.

The deceptive signature pattern broadcast system remains active and functioning during periods or places of vulnerability. In the above embodiments, there is no need for detection capability on board or associated with the host platform. However, the system can be utilized in conjunction with a detection system to become an active, rather than a passive, system. For example, the countermeasure system may be automatically activated by an onboard missile warning system when a missile is detected within a certain range of the asset (i.e., about 100 feet to about 20,000 feet). It is understood that missile warning systems improve with the application of new technology; therefore, the present invention encompasses the ability to detect incoming missiles from a variety of ranges of the asset. Likewise, the countermeasure system may be automatically activated when the altimeter decreases below a certain value (i.e., the aircraft is flying below about 15,000 feet to about 20,000). It is understood that missile effective ranges improve with the application of new technology; therefore, the present invention encompasses the ability to activate at higher altitudes.

All types of threat vehicles are contemplated, including land-based, stationary, seaborne, undersea and outer space mediums, and host assets. The threat vehicles include aircraft, missiles, land and sea surface borne vehicles, and torpedoes.

Although aircraft are illustrated in the above examples, other assets are contemplated. The above embodiments of the present invention extend to protective systems for airplanes, helicopters, ships, tanks, trucks, amphibious vehicles, reentry space vehicles including ballistic missiles, and even to stationary targets such as sea-based oil rigs, power plants, pumping stations, and any mobile or fixed asset for which some type of signature quality or targetable electromagnetic emissions is a necessary byproduct of its normal functionality.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A central laser source based passive countermeasure system for use on an emission producing asset comprising:
at least one centrally located source disposed on the emission producing asset, said at least one centrally located source configured to produce optical energy in at least one band of infrared radiation;
at least one first fiber optic wire coupled to said at least one centrally located source to transmit said optical energy;
at least one modulator coupled to said at least one centrally located source via said at least one first fiber optic wire and configured to modulate a flow of said optical energy; and
at least one output lens assembly coupled to said at least one modulator via at least one second fiber optic wire and configured to receive said optical energy and emit said optical energy.

2. The apparatus of claim 1, wherein said at least one modulator is at least one of an electro-optic modulator.

3. The apparatus of claim 1, wherein said at least one fiber optic cable is a single mode fiber optic cable.

4. The apparatus of claim 1, wherein said at least one band of infrared radiation is at least one of Band 1 radiation and Band 4 radiation.

5. The apparatus of claim 1, wherein said at least one centrally located source is at least one of a carbon monoxide laser and a solid state laser.

6. The apparatus of claim 1, wherein said at least one output lens assembly is disposed on at least one of a wing tip, a tail tip, a belly, and a nose of the emission producing asset.

7. The apparatus of claim 1, wherein the emission producing asset is at least one of airplanes, helicopters, ships, tanks, trucks, amphibious vehicles, reentry space vehicles, sea-based oil rigs, power plants, pumping stations, and any mobile or fixed asset for which some type of signature quality or targetable electromagnetic emissions is a necessary byproduct of its normal functionality.

8. The apparatus of claim 1, wherein said at least one output lens assembly is an aspheric output and fiber interface mounted in a hermetically sealed aerodynamically shaped housing.

9. The apparatus of claim 8, wherein said aspheric optical element has an anti-reflection coating.

10. The apparatus of claim 1, wherein said at least one output lens assembly has deicing capabilities.

11. The apparatus of claim 1, further comprising:
at least one other centrally located source.

12. The apparatus of claim 1, wherein said at least one centrally located source is automatically activated when a missile is detected within about 100 feet to about 20,000 feet of the emission producing asset.

13. A method of using a central laser source based passive countermeasure system on an emission producing asset comprising:
activating at least one centrally located source to produce optical energy in at least one band of infrared radiation;
coupling said at least one centrally located source to at least one first fiber optic wire;
transmitting said optical energy through said at least one first fiber optic wire to at least one modulator;
modulating a flow of said optical energy in said at least one modulator;
transmitting said flow of said optical energy to at least one output lens assembly via at least one second fiber optic wire; and
emitting said flow of said optical energy from said at least one output lens assembly.

14. The method of claim 13, wherein said optical energy is at least one of Band 1 radiation and Band 4 radiation.

15. The method of claim 13, wherein said emitting said flow of said optical energy is emitted from said at least one output lens assembly disposed on at least one of airplanes, helicopters, ships, tanks, trucks, amphibious vehicles, reentry space vehicles, sea-based oil rigs, power plants, pumping stations, and any mobile or fixed asset for which some type of signature quality or targetable electromagnetic emissions is a necessary byproduct of its normal functionality.

16. The method of claim 13, further comprising:
providing deicing capabilities to said at least one output lens assembly.

17. The method of claim 13, further comprising:
automatically activating said at least one centrally located source when a missile is detected within about 100 feet to about 20,000 feet of the emission producing asset.

18. The method of claim 13, wherein said at least one centrally located source is at least one of a carbon monoxide laser and a solid state laser.
